(19) United States
(12) Patent Application Publication
(10) Pub. No.: US 2002/0129037 A1
(43) Pub. Date: Sep. 12, 2002

(54) Method for accessing a database

(76) Inventor: Peo Nathan, Shrewsbury, MA (US)

Correspondence Address: BROMBERG & SUNSTEIN LLP, 125 SUMMER STREET, BOSTON, MA, 02110-1618, US

(21) Appl. No.: 10/037,613

(22) Filed: Jan. 4, 2002

Related U.S. Application Data
(60) Provisional application No. 60/260,238, filed on Jan. 8, 2001.

(51) Int. Cl. G06F 7/00

(52) U.S. Cl. 707/104.1

(57) ABSTRACT

A method is provided to store data in a computer database so that data from multiple organizations may be accessed by users employing a single instance of an application. Use of an organizational identifier for each data record allows a common set of database tables to hold data from all organizations. User access to data in the database is restricted based on the organizational identifier.

This application claims priority from provisional U.S. Patent Application No. 60/260,238, filed Jan. 8, 2001, entitled “Method for Accessing a Database,” attorney docket number 2496/101, which is incorporated by reference herein in its entirety.

### TECHNICAL FIELD

The present invention relates to methods of database management and processing, and in particular to methods facilitating access to databases that comprise data from multiple organizations.

### BACKGROUND OF THE INVENTION

Various methods have been developed in the art of database systems to enable processing and storage of business information derived from multiple organizations. It is typical for multiple users to interact with such systems and a method for allowing individual users to access information from only selected organizations is often required.

One method for organizing such a system employs “disk space sharing.” In this method, each organization is assigned its own storage, which is separate and distinct from the storage of other organizations. Each organization builds its database on this disk storage. These databases are stored in separate areas in disk storage units. Each organization develops its own application program to run on a timeshared computer that is connected to and controls the disk storage unit containing the databases. Each organization's application program accesses only that organization's database. This method employs the computer's operating system to facilitate sharing of the processing and data storage hardware. Security of each organization's data is maintained by procedures that restrict users from gaining access to an organization's application program and file access restrictions enforced by the computer's operating system. Drawbacks of this method include the need to develop separate applications and maintain separate databases for each organization.

A second method employs sharing at the database management system (“DBMS”) level. In a typical arrangement, a single database is implemented on a computer's disk storage unit. Each organization maintains its data in separate files or table in the database reserved for that organization, e.g., VSAM files on mainframes or separate tables in a Relational Database Management System (“RDBMS”) such as the products from Oracle, Informix or Sybase. Each organization still develops its own application program that runs on the shared computer processor to access its portion of the database. A drawback of this organization is the high level of maintenance that such a database organization implies and the requirement to maintain separate applications for each organization.

An improved approach according to one embodiment of the present invention allows users from different organizations to share the same instance of an application program running on a computer processor and to share a common database at the level of data tables in the database that are common to all organizations using the system. This approach requires a method of ensuring that users from one organization cannot gain access to data belonging to another organization.

### SUMMARY OF THE INVENTION

In a preferred embodiment of the invention, a method for processing business information generated by multiple organizations is performed on a data processing system. The method comprises providing a database for holding business information; receiving business information from a plurality of organizations; populating the database with business information from the plurality of organizations, the business information being identified with an organizational identifier identifying the organization associated with the information: authenticating a user for access to the database based on a user identifier. a password and the organizational identifier: and providing the user access to the database only for business information identified with the user's organizational identifier.

### BRIEF DESCRIPTION OF THE DRAWINGS

FIG. 1 is a block diagram of a data processing system operating in accordance with an embodiment of the present invention.

FIG. 2 is a flow chart showing user login authentication.

FIG. 3 is a chart showing an example of the organization of business information in the database.

FIGS. 4-6 are charts showing the business information retrieved from the database and displayed for a first, a second and a third user.

### DESCRIPTION OF A PREFERRED EMBODIMENT

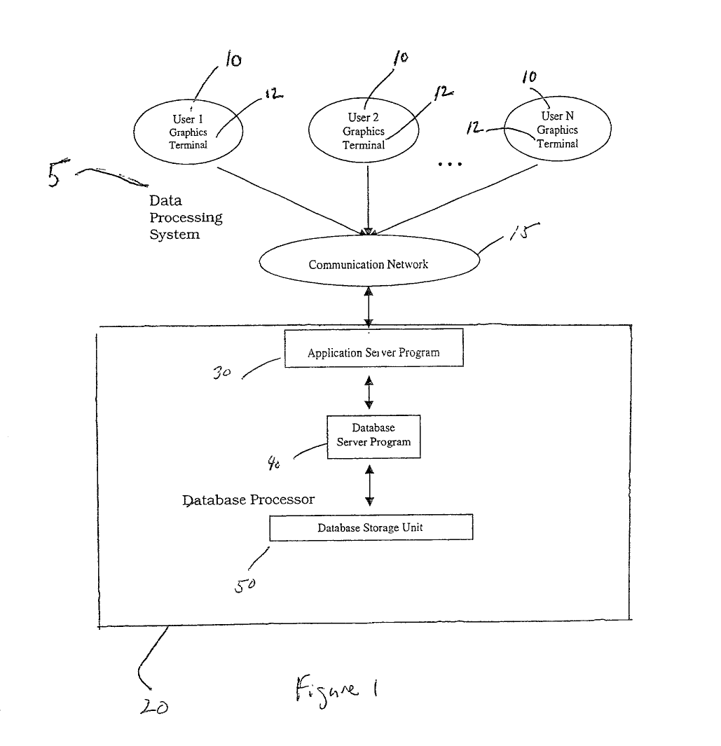

In one embodiment of the invention, a data processing system 5 is provided, as shown in the block diagram of FIG. 1. Users 10 access the data processing system 5 from graphics terminals 12, that may be personal computers. A communication network 15 connects user graphics terminals 12 to a database processor 20. The communication network may be any means of communications among digital systems, such as the internet, point-to-point modem connections or direct wire connections. The database processor 20, that may be a general purpose computer or a cluster of computers, executes an application server program 30 and a database server program 40. The database server 50, that may be magnetic disk storage units.

Users 10 interact with the data processing system 5 by communicating with the application server program 30. The application server program 30 is a single program executable that serves all users of the data processing system. The application server program 30 sends a graphical interface to the graphics terminals 12 for the users 10 to input and to view business information. The application server program 30 sends data received from users to and receives data from the database server program 40.

The database server program 40 receives data from the application server program 30 and sends data to the database storage unit 50. The data sent to the database storage unit is formatted and saved in a “database.” The database server program 40 services requests from the application server program 30 for data from the database, retrieving the requested data from the database 50 and forwarding the requested data to the application server program. The database server program 40 also stores information received from the application server program in the database.

The database server program 40 accesses the database, using Oracle Database technology. Oracle Developer Server Technology is used to implement the application server program. However, any RDBMS and web development and reporting tool with equivalent functionality may be used. The user-interface screens, otherwise called “forms”, are generated using Oracle Forms Server. The reporting interface is generated using Oracle Report Server. All of the data processing system 5 users use the same screens to view, create and modify their data and share the same executable application server program 30 for accessing data. The screens and reports were built on database views that provide access to each organization's data. The set of database views, on which the forms and reports function, reside in the Oracle database and are of same name for each organization but show data that belongs only to a particular organization. The database processor runs on the Microsoft Windows NT 4.0 operating system, but other operating systems with similar functionality, such as Unix, can be employed.

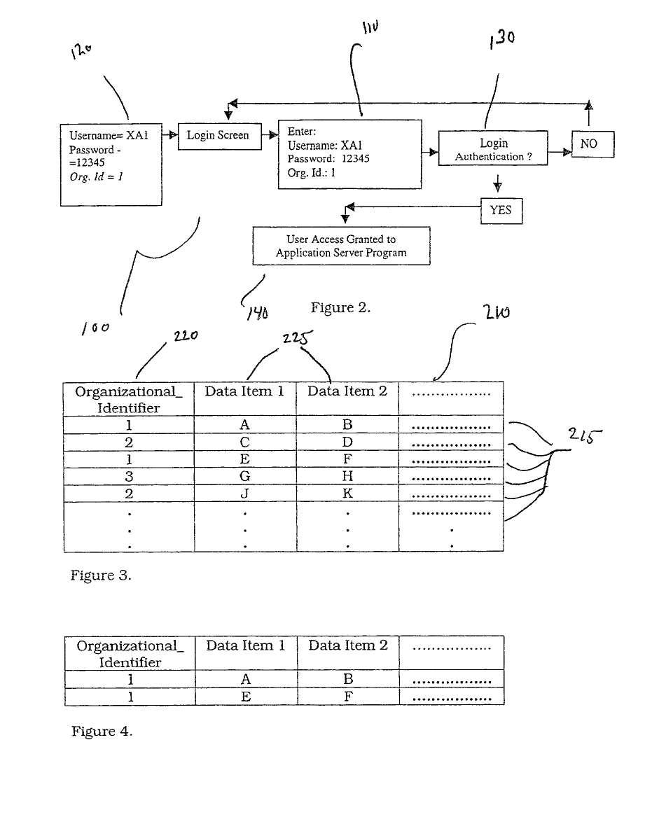

Users 10 gain access to the database processor 5 through a login authentication process 100 as shown in FIG. 2, by communicating with the database server program 40 through the application server program 30. The user 10 enters a username, a password, and an organizational identifier via the graphics terminal 10. In FIG. 2, the user's username is “XA1”. the password is “12345” and the organizational identifier is “1.” The login authentication process 100 verifies that the username, password and organizational identifier are contained in an entry in an authentication table, that is stored on the data storage unit. If the login authentication 130 verifies that the information entered corresponds to a valid entry in the authentication table, the user is granted access 140 to the other functions performed by the application server program 30. The organizational identifier may be an integer or an alphanumeric string and is unique for each organization.

Users 10 enter business information into the data processing system 5 via the user's graphics terminal 12, communicating with the application server program 30 via the communications network 15. Each item of business information entered is associated with an organization, whose data is maintained in the database. Each organization is associated with the unique organizational identifier for that organization. Each data record in the database is tagged with the organizational identifier for the associated organization. User-entered data is tagged with the organizational identifier that the user entered in the login authentication process 100. The method for associating the organizational identifier with the data elements in the database is described below.

The database server program 40 stores user-entered data received from the application server program 30 in the database. FIG. 3 shows the organization of the business information into a database table 210. The table comprises one or more records 215. Each record contains a minimum of two data elements: the organizational identifier 220 for the data record and one or more data items 225.

Users 10 access the business information stored in the data processing system via the user's graphics terminal 12, communicating with the application server program 30.

The application server program 30 ensures that a user can gain access only to those records in the database that are tagged with the organizational identifier that corresponds to that user's organizational identifier. This process is illustrated with sample structured query language (“SQL”) code that creates a view on the table shown in FIG. 3. for each of three users. Uₓ, U_{y} and U_{z}. (Note that the three users are not shown in FIG. 3). Users Uₓ, U_{y} and U_{z} have logged in with organizational identifiers that equal “1”, “2” and “3” respectively, corresponding to organizations X, Y and Z respectively. Each user will access only those views created for that user.

For user Uₓ from Organization X with organizational identifier “1:”

CREATE VIEW XU.V AS SELECT * FROM APP.T

WHERE ORGANIZATION_IDENTIFIER = 1
WITH CHECK OPTION:

The above SQL code in the database creates the view shown in FIG. 4 that will display only organization X's data in Uₓ's XU schema.

For User U_{y} from Organization Y with organizational identifier “2:”

CREATE VIEW YU.V AS SELECT * FROM APP.T

WHERE ORGANIZATION_IDENTIFIER = 2
WITH CHECK OPTION;

The above SQL code in the database creates the view shown in FIG. 5 that will display only organization Y's data in U_{y}'s YU schema.

For User U_{z} from Organization Z with organizational identifier “3:”

CREATE VIEW ZU.V AS SELECT * FROM APP.T

WHERE ORGANIZATION_IDENTIFIER = 3
WITH CHECK OPTION;

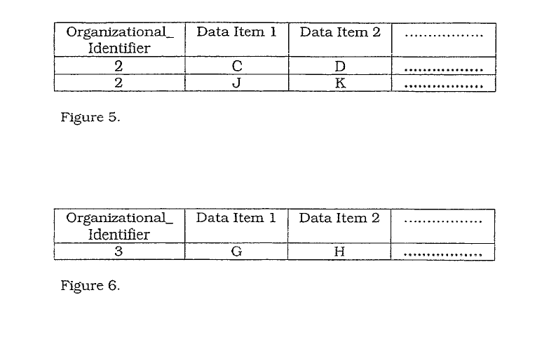

The above SQL code for the database creates the view shown in FIG. 6 that displays only organization Z's data in U_{z}'s ZU schema.

Each user 10, thus, gains access only to the data corresponding to the organizational identifier that was authenticated for the particular user during the login authentication process 100. Each user is prevented from viewing information in the database that is not tagged with the user's organizational identifier.

Although a preferred embodiment of the invention has been disclosed, it should be apparent to those skilled in the art that various changes and modifications can be made which will achieve some of the advantages of the invention without departing from the true scope of the invention. These and other obvious modifications are intended to be within the scope of the invention.

Preferred embodiments of the invention may be implemented as a computer program product for use with a computer system. Such implementation may include a series of computer instructions fixed either on a tangible medium, such as a computer readable media (e.g., a diskette, CD-ROM, ROM, or fixed disk) or transmittable to a computer system, via a modem or other interface device, such as a communications adapter connected to a network over a medium. Medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system: Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g. shrink wrapped software), preloaded with a computer system (e.g., on system ROM or fixed disk), or distributed from a server or electronic bulletin board over the network (e.g., the Internet or World Wide Web)

What is claimed is:

1. A method performed on a data processing system for processing business information generated by multiple organizations, the method comprising:
a. providing a database for holding business information;
b. receiving business information from a plurality of organizations:
c. populating the database with business information from the plurality of organizations, the business information being identified with an organizational identifier identifying the organization associated with the information;
d. authenticating a user for access to the database based on a user identifier, a password and the organizational identifier; and
e. providing the user access to the database only for business information identified with the user's organizational identifier.

2. A method according to claim 1, wherein the step of providing the user access to the database is provided by a single instance of a database server program for all users.

3. A method according to claim 1, wherein the step of providing the user access to the database is provided by a single instance of an application server program for all users.
